(19) United States
(12) Patent Application Publication
(10) Pub. No.: US 2025/0053962 A1
(43) Pub. Date: Feb. 13, 2025

(54) APPARATUS AND METHOD FOR SCORING DIGITAL IDENTITY ATTRIBUTE LEVELS IN A COMPUTER NETWORK WITH MULTIPLE ENTERPRISE PARTICIPANTS

(71) Applicant: Dentity Partners, Inc., Los Angeles, CA (US)

(72) Inventors: Jeffrey SCHWARTZ, Los Angeles, CA (US); Justin SCHWARTZ, Los Angeles, CA (US); Matthew SCHWARTZ, Los Angeles, CA (US)

(21) Appl. No.: 18/453,997

(22) Filed: Aug. 22, 2023

Related U.S. Application Data
(63) Continuation-in-part of application No. 18/448,855, filed on Aug. 11, 2023.

(51) Int. Cl. G06Q 20/36

(52) U.S. Cl. CPC G06Q 20/367; G06Q 20/363

(57) ABSTRACT

An apparatus has a network interface circuit to provide connectivity to a network. A processor is connected to the network interface circuit. A memory is connected to the processor. The memory stores instructions executed by the processor to receive a registration request from an identification issuer machine. A distributed identification (DID) is assigned to an identification issuer machine. The DID is registered at an identification registry machine. An identification request is received from an identification holder machine. Verified identification evidence is collected from identification validation machines. A verified identification credential with an associated Digital Identity Attribute Level (DIAL) is issued to a holder wallet associated with a user of the identification holder machine. The verified identification credential and DIAL in the holder wallet is accessible only with permission from the user of the identification holder machine, which is selectively granted to different machines over time to establish a reusable digital identity.

### CROSS-REFERENCE TO RELATED APPLICATION

This application is a continuation-in-part of U.S. application Ser. No. 18/448,855, filed Aug. 11, 2023.

### FIELD OF THE INVENTION

This invention relates generally to identity verification in a computer network. More particularly, this invention is directed to identity verification scoring in a computer network with multiple enterprise participants.

### BACKGROUND OF THE INVENTION

There are several different standards for assessing and verifying digital identities. These standards are not always compatible with one another. This makes it difficult for businesses to interpret and interact with digital identities and to comply with regulatory requirements. Further, consumers must continually re-verify their identity as they move from platform to platform, which increases the chances that personal information may be breached or misused. Consumers cannot easily save and reuse their identity verification and share verified identity information in a privacy respecting way.

Thus, there is a need to address these shortcomings in existing systems.

### SUMMARY OF THE INVENTION

An apparatus has a network interface circuit to provide connectivity to a network. A processor is connected to the network interface circuit. A memory is connected to the processor. The memory stores instructions executed by the processor to receive a registration request from an identification issuer machine. A distributed identification (DID) is assigned to an identification issuer machine. The DID is registered at an identification registry machine. An identification request is received from an identification holder machine. Verified identification evidence is collected from identification validation machines. A verified identification credential with an associated Digital Identity Attribute Level (DIAL) is issued to a holder wallet associated with a user of the identification holder machine. The verified identification credential and DIAL in the holder wallet is accessible only with permission from the user of the identification holder machine, which is selectively granted to different machines over time to establish a reusable digital identity.

### BRIEF DESCRIPTION OF THE FIGURES

The invention is more fully appreciated in connection with the following detailed description taken in conjunction with the accompanying drawings, in which:

FIG. 1 illustrates a system configured in accordance with an embodiment of the invention.

FIG. 2 illustrates machine interactions performed in accordance with an embodiment of the invention.

FIG. 3 illustrates verified credential issuance operations performed in accordance with an embodiment of the invention.

FIG. 4 illustrates identity verification operations performed in accordance with an embodiment of the invention.

FIG. 5 illustrates Digital Identity Attribute Level (DIAL) scoring performed in accordance with an embodiment of the invention.

Like reference numerals refer to corresponding parts throughout the several views of the drawings.

### DETAILED DESCRIPTION OF THE INVENTION

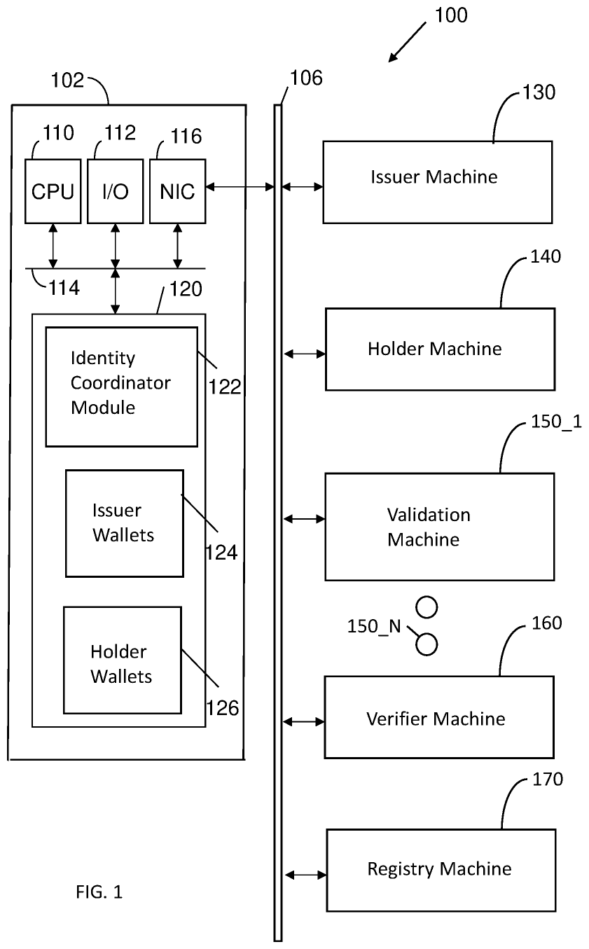

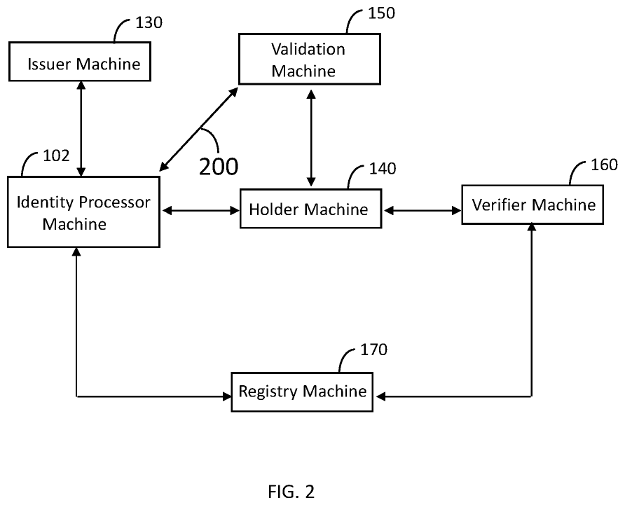

FIG. 1 illustrates a system 100 configured in accordance with an embodiment of the invention. The system 100 includes an identity coordinator machine 102 in communication with a network 106, which includes any combination of wired and wireless networks. As shown with identity coordinator machine 102, each machine in the system 100 includes a processor 110 connected to input/output devices 112 via a bus 114. The input/output devices 112, may include a keyboard, mouse, touch display and the like. A network interface circuit 116 is also connected to bus 114 to provide connectivity to network 106. A memory 120 is also connected to bus 114. The memory 120 stores instructions executed by processor 110 to implement operations disclosed herein. In one embodiment, the memory 120 stores an identity coordinator module 122 to implement operations shown in connection with FIGS. 2-4. After an identity issuer is registered, a digital wallet for the identity issuer is maintained with other issuer wallets 124. Similarly, after a user's identity is verified, the user has a holder wallet stored along with other holder wallets 126.

System 100 also shows an issuer machine 130. An issuer machine 130 is controlled by an issuer of a verifiable credential. Verifiable credentials are issued in accordance with an open standard created by the World Wide Web Consortium (W3C) to express credentials in a networked environment. Verifiable credentials can represent information found in physical credentials, such as a passport or license, as well as new things that have no physical equivalent, such as ownership of a bank account. Verifiable credentials are cryptographically secure, privacy respecting, machine-verifiable and interoperable across systems. They are held by consumers (the holder of the credential) in a digital wallet, such as holder wallets 126.

The issuer machine 130 characterizes one or more subjects, creating a verifiable credential that is transmitted to a holder (e.g., to the holder's digital wallet 126). Example issuers include corporations, non-profit organizations, trade associations, governments, and individuals. In the system of FIG. 1, the issuer machine 130 deploys the identity coordinator machine 102 to issue a credential on its behalf.

FIG. 1 also illustrates a holder machine 140 connected to network 106. The holder machine is controlled by a credential holder, which is an entity that has been issued a verifiable credential. In the system of 100 the holder is the user of holder machine 140 who has verified his or her identity and holds a verified identity credential in a holder wallet 126 (on machine 102 or locally).

FIG. 1 also illustrates a validation machine 150 connected to network 106. The validation machine 150 performs visual ID verification of the authenticity of a government-issued document. This process includes analyzing data points on the physical identification document, conducting a biometric scan of the individual and resolving the identity as verified using computer vision and artificial intelligence.

A verifier machine 160 is also connected to network 106. The verifier machine 160 is operated by an entity that relies upon the holder's authenticators and credentials or a verifier's assertion of a claimant's identity, typically to process a transaction or grant access to information or a system.

Finally, system 100 includes a registry machine 170, which maintains a verifiable data registry. The verifiable data registry mediates the creation and verification of identifiers, keys, and other relevant data, such as verifiable credential schemas, revocation registries, issuer public keys and the like, which might be required to issue and verify verified identity credentials. Example verifiable data registries include trusted databases, decentralized databases, and distributed ledgers or blockchains.

The registry machine 170 relies upon decentralized identifiers (DIDs), which are a new type of identifier that enables verifiable, decentralized digital identity. A DID refers to any subject (e.g., a person, organization, thing, data model, abstract entity, etc.) as determined by the controller of the DID. In contrast to typical federated identifiers (like phone numbers or email addresses), DIDs have been designed so that they may be decoupled from centralized registries, identity providers, and certificate authorities.

It should be appreciated in reference to FIG. 1 that the identity coordinator machine 102 operates to coordinate operations among multiple enterprise participants in a network, including enterprise participants operating issuer machine 130, holder machine 140, validation machine 150, verifier machine 160 and registry machine 170.

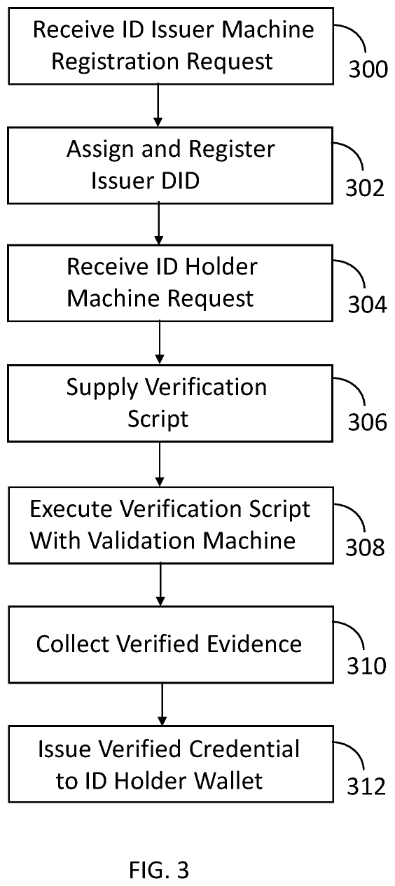

FIG. 2 illustrates machine interactions performed in accordance with an embodiment of the invention. FIG. 3 illustrates processing coordinated by the identity processor machine 102. Referring to FIG. 3, initially, the identity processor machine receives an ID issuer machine registration request 300. FIG. 2 illustrates the issuer machine 130 interacting with the identity processor machine 102. The identity processor machine assigns and registers an issuer DID 302. That is, the identity processor machine 102 interacts with registry machine 170 to anchor the DID within the registry and supply the identity processor machine 102 with DID controller information.

Anchoring the DID to the registry machine 170 means publishing the identifier so it can be resolved by counter parties that want to verify a credential. Every customer wallet, and each credential, technically has a DID, but these are not public and discoverable, only issuer DIDs are discoverable. Unlike crypto wallets, which have their wallet address on chain, the disclosed system adopts a more privacy respecting approach because it is related to individual identity. If one publishes wallet addresses and credential identifiers on chain, others are able to easily discover what credentials a holder has in a wallet. Like crypto today, this could be discovered so others could track wallets and credentials.

The identity processor machine then receives an ID holder machine request 304. FIG. 2 illustrates the identity processor machine 102 interacting with the holder machine 140. In response to the request from the ID holder machine, the identity processor machine 102 supplies a script for the holder machine 140 to execute. The script, which includes instructions executed by a processor of the holder machine 140 causes the holder machine 140 to interact with the validation machine 150.

In one embodiment, the validation machine 150 is controlled by a third-party service. In one embodiment, the third-party service executes three steps: verifying identity data, authentication of IDs, and liveness verification. During the initial verification process the user starts with basic data input prompted by the verification script. The validation machine 150 then runs checks such as behavioral analytics, email, phone, device, and network risks, and checks for synthetic and stolen identities. The script then prompts the holder machine 140 to scan the front, and back (if applicable), of the individual's government issued ID document, which is supplied to the validation machine 150. The validation machine 150 checks include font injections, alteration of images, and proof that the document is in its physical form. The script then prompts the user to capture a 3D selfie video of the individual, prompting the user to rotate their head to prove liveness, while running comparison checks on the 3D video and the image from the document scanned. Alternately, the script may prompt for photographs. Information collected by the validation machine 150 is then obtained by the identity processor machine 102 using application program interface (API) calls over network 106, as shown with arrow 200 in FIG. 2. This is also shown as step 310 of FIG. 3.

A verified credential is then issued to an ID holder wallet 312. FIG. 1 shows holder wallets 126. Each holder wallet stores credentials and manages the keys required for authentication. Machine 102 may be a dedicated server or a node in a cloud service. Again, while the issuer machine DID is on registry machine 170, the holder DID is only resident on the identity processor machine 102 to preserve privacy for each holder.

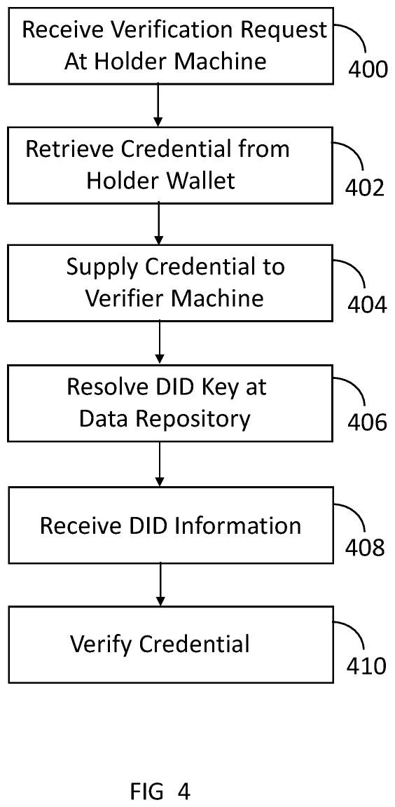

FIG. 4 illustrates a verification process in accordance with an embodiment of the invention. A verification request is received at a holder machine 400. As shown in FIG. 2, verifier machine 160 may send a request to holder machine 140.

A credential is then retrieved from the holder's wallet 402 and is supplied to the credential verifier machine 404. FIG. 2 shows the holder machine 140 accessing the identity processor machine 102, which stores the holder's wallet. The credential is then passed from the identity processor machine 102, to the holder machine 140 to the verifier machine 160.

The next operation of FIG. 4 is to resolve the DID key at the data repository 406. FIG. 2 illustrates DID key interactions between verifier machine 160 and registry machine 170. Identity processor machine 102 may perform similar operations with registry machine 170 for record keeping purposes. Observe here that the verifier machine uses the registry machine as a decentralized authority to verify a holder's credentials. Further observe that the holder can use the information in a holder wallet as a reusable digital identity for many verifier machines.

Returning to FIG. 4, the next operation is to receive DID information (DID document) from the registry machine 170, which is used by the verifier machine to verify the credential 410. The DID information includes verification methods, such as cryptographic public keys and services relevant to interactions with the DID. The verification operation may include a digital signature schema to verify or decrypt information when the holder shares credentials for the verifier.

Those skilled in the art will recognize several advantages associated with the disclosed technology. Consumers are given a right to “own” a verified form of their digital identity. The digital identity is easy to share, is reusable, and is secure. Consumers benefit from the use of open protocols-particularly those developed by the W3C, including Verifiable Credentials, Decentralized Identifiers, and digital wallets. These protocols provide a playbook for interoperability, which drives consumer adoption.

Consumers worry about sharing personal and financial information online with people they do not know or websites they do not trust. They may be inviting a service provider to their home, buying or selling online, or if they are unlucky, they may run into a bad actor on social media who is hiding behind an anonymous or a fake profile.

These are all use cases where a verified digital identity, in a sharable form factor, would be invaluable. Requesting verified information from someone who is visiting your home could be a lifesaver, and not oversharing personal information could reduce your risk of identity theft caused by a data breach. If users widely shared their verified profile link on social media, it would be easier to root out the predators who commonly troll these sites.

Businesses face a different set of problems. Bad actors are everywhere, and they continue to raise the bar from a fraud sophistication perspective. Businesses are increasingly forced to combat malicious actors and bot technology with counter measures that increase the certitude of liveness and verify the presence of an identity. For some businesses, these Know Your Customer (KYC) efforts are not a luxury but a regulatory requirement. However, adding KYC to an onboarding process increases costs and customer friction. Consumers get frustrated with having to verify their information on every platform they visit, and they are rightly circumspect about turning over more of their personal information to another website. The model of saving more and more personal information to a database has not proven resilient to data hacks, and that's one reason why identity theft has reached epidemic proportions.

Businesses also suffer from the lack of liquidity in the market for KYC credentials. There has not been a standardized nomenclature, or ranking system, for identity verifications, which has limited the ability for business to collaborate and reduce costs. In the absence of such a standard, a market has not developed around the reuse of identity credentials, and businesses have been forced to develop their KYC programs in a silo. This has resulted in spiraling KYC costs and no clear pathway to realizing future economic value from investments in KYC.

In one embodiment, the identity coordinator module 122 is a web app that gives consumers greater control of their digital identity and allows them to reuse it across platforms. Their digital identity facilitates new functions, like proving age without disclosing a birthdate, or verifying identity without sharing a name. For consumers, experiencing the magic of reusing their digital identity is priceless—a lifetime of pain caused by typing their personal information into another web form seems to melt away.

Businesses can easily configure identity verification agents, configure a relying party client for their website, and issue credentials to their stakeholders. This disclosed portal is self-service, pay-as-you-go, and offers a range of integration options that meet a wide range of use cases.

An embodiment of the invention verifies over 2,000 government-issued ID documents from 200+ countries. The disclosed solution is compliant with the Department of Commerce Digital Identity Guidelines (NIST 800-63-3), which facilitates adoption by US-based regulated entities. The identity coordinator module 122 integrates with numerous ID tech companies (validation machines 150) and offers a range of flexible verification solutions, including visual ID verification, financial account verifications (from over 10K institutions), data verifications, and social media verifications, among others.

The disclosed issuer wallets 124 and holder wallets 126 are custodial cloud wallets for consumers and can issue Verifiable Credentials (VC) using JSON-LD among other data formats and programming languages. The identity coordinator module 122 issues verified identity credentials, and businesses can issue any type of credential to their stakeholders, including membership and loyalty credentials. Issued credentials are verifiable online and interoperable with other digital wallets, including Apple® and Google®. The VC data model is optimal for identity credentials because they are non-transferrable (soul-bound), revokable, and divisible (consumers can choose to present only certain claims from a credential, which prevents oversharing). The identity coordinator module 122 also includes a first-of-its-kind marketplace for Verifiable Credentials where businesses can post credentials and build a community of wallet-holders.

An embodiment of the identity coordinator module 122 is an OpenID Connect (OIDC) application for Verifiable Presentations, which is compliant with W3C standards and allows credentials to be verified online. The OIDC application is an approved Enterprise Connection in customer identity and access management systems. It is built in a way that allows a relying party to configure and setup an OIDC client on their website in a matter of minutes.

The disclosed system allows for decentralized identity, consistent with the best principles of Self-Sovereign Identity (SSI). By standardizing on Verifiable Credentials as a form factor for digital identity, and by anchoring decentralized identifiers to a verifiable data registry, for example, the Bitcoin blockchain, the system gives consumers greater control over their digital identity and businesses access to a growing network of verified consumers with reusable credentials, lowering KYC costs and reducing onboarding friction.

Verified digital identity is expressed in several form factors. Verified identity is expressed as a Verifiable Credential in a wallet. VC's have wide-ranging functionality and are a key ingredient to make decentralized identity work. Verified identity is also expressed as a Verified Profile Page, which can be customized by the holder and shared across their channels. This page conducts a real-time blockchain verification and gives the holder 1:1 and 1:N verification options. Verified identity is also expressed as an Apple® or Google® wallet pass. These passes can be presented at point-of-sale and can be tagged with an NFC chip. Finally, verified identity is expressed as a Verify Request, a feature in the identity coordinator module 122. These zero knowledge proof requests are peer-to-peer and are only accessible to holders of a verified identity credential.

An embodiment of the invention offers enterprise users a fully featured portal where they can create identity verification agents, configure OIDC clients, view a ledger of their network activity, create and issue credentials, message credential holders, and conduct account administration. An embodiment of the invention offers enterprise customers a robust, well-documented set of APIs as well as low-code and no-code integration options.

The disclosed technology provides techniques for verifying digital identities. An embodiment of the invention characterizes the strength of a verified digital identity. This strength measure allows entities to evaluate the likelihood of a fraudulent actor. The technique relies upon multiple machines providing verified evidence. Thus, FIG. 1 shows a collection of validation machines 150_1 through 150_N.

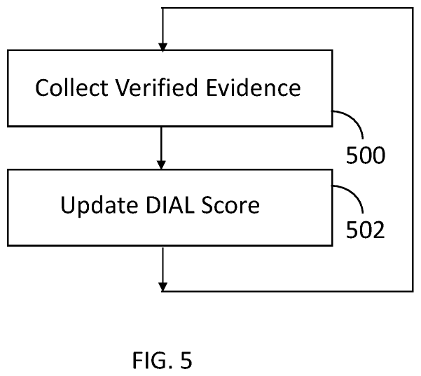

FIG. 5 illustrates the identity coordinator module 122 performing a closed loop process with an operation to collect verified evidence 500 and then to update a Digital Identity Attribute Level (DIAL) score 502.

In one embodiment, a DIAL is a numeric value based on the completion of various verifications. The DIAL is a verifiable credential that can be verified with verifier machine 160. The DIAL is held in a holder wallet 126. The DIAL credential can be cryptographically verified using a DID in combination with the registry machine 170.

Using DIAL, consumers can exchange and verify identity credentials peer-to-peer, and large enterprises can use DIAL and the identity coordinator module 122 to onboard and verify their users.

DIAL verifies and categorizes attributes of a digital identity, from weakness to strength, based on the completion of certain verifications, including visual ID document verifications and biometric verifications, among others. The DIAL system assigns an attribute ranking to a subject's digital identity, giving it a numeric value. The DIAL system issues the holder of the identity a Verifiable Credential (based on W3C standards), which contains certain verified identity information and which is held by the consumer in a digital wallet, such as holder wallet 126. A DID is created (based on W3C standards) on a Verifiable Data Registry (e.g., registry machine 170) which can be verified by a relying party using the verifier machine 160.

The DIAL system delivers the promise of reusable identity to the consumer, while providing the standards required by enterprises, including those that are subject to KYC requirements. It codifies—and transforms into a Verifiable Credential—the standards set by the Department of Commerce Digital Identity Guidelines and NIST 800-63-3, U.S. domestic and international Anti-Money Laundering (AML) regulations, and well-established protocols, like Fast Identity Online (FIDO).

DIAL provides relying parties and identity originators (the party who seeks to onboard verified users) an OpenID Connect client (based on W3C standards) and an API which allows them to verify and/or onboard users at a given DIAL level. Further, DIAL provides a system to facilitate payments between relying parties, credential issuers, and identity originators, creating a network effect which incentivizes all parties to originate and verify identities using the DIAL system.

The collected verified evidence comes from a variety of validation machines 150_1 through 150_N. The verified evidence may include self-attested data, third-party data, physical ID documents, biometric data, proof of liveness data, device data, network data, authoritative source data, knowledge-based authentication, and two-factor authentication.

In one embodiment, the identity coordinator module 122 collects self-asserted data. Self-asserted data is evidence that the consumer (hereafter, the “subject”) inputs into a web form or app supplied by machine 102 to holder machine 140.

The identity coordinator module 122 integrates with and collects data from third party data providers. Third party providers allow the identity coordinator module 122 to augment, enhance, validate, and ultimately verify identity evidence collected or supplied by the subject.

The identity coordinator module 122 collects data from government-issued identity documents. Data collection is completed through visual ID verification, which seeks to examine the physical characteristics of the document, extract certain information, then validate and verify the extracted data.

The identity coordinator module 122 collects biometric and proof of liveness data. The data is collected through automated software programs which meet known technical standards, including the FIDO protocols. FIDO uses standard public key cryptography techniques to provide stronger authentication. During registration with the identity coordinator module 122, the subject's client device creates a new key pair. It retains the private key and registers the public key with the identity coordinator module 122. A subject's unique biometrics—for example, Face ID or Touch ID—control access to the private key at the holder machine 140.

In one embodiment, the identity coordinator module 122 collects information from the device and network of the subject. The identity coordinator module 122 assesses risk factors which impact identity resolution.

The identity coordinator module 122 also integrates with and collects data from other authoritative sources. These sources may include data providers, registries, and national organizations, such as financial institutions, which impact identity resolution.

The identity coordinator module 122 collects knowledge-based data from the subject. This data may include certain attributes that are known to the subject relative to their background or identity.

In one embodiment, the identity coordinator module 122 requires two-factor authentication during the evidence collection process. Two-factor authentication includes, but is not limited to, sending a code to the subject's mobile device or email address.

Consider an embodiment of the invention with five DIAL levels. Level 1 is assigned when a subject completes two-factor authentication and passes certain anti-bot/anti-spam measures. Level 2 is for a subject who meets the requirements of level 1 and who has proven liveness based on established standards and protocols. Level 3 is for a subject that meets the requirements of level 2 and who has verified their identity using a government-issued identity document. The evidence supports the real-world existence of the claimed identity and verifies that the applicant is appropriately associated with this real-world identity. Level 4 is for a subject who meets the requirements of level 3 and who has passed Anti-Money Laundering (AML) screening. Level 5 is for a subject who meets the requirements of level 4 and who has been verified in compliance with the NIST (National Institute of Standards and Technology) 800-63-3 Digital Identity Guidelines with respect to strength of evidence. DIAL levels will expand over time as unique use cases are presented.

The DIAL level is maintained in a holder wallet 126. The DIAL level is shared using the process of sharing a verified credential as set forth in FIG. 4.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include but are not limited to: magnetic media, optical media, magneto-optical media, and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using an object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. An apparatus, comprising:
a network interface circuit to provide connectivity to a network including an identification issuer machine, an identification holder machine, an identification validation machine, identification verifier machines and an identification registry machine;
a processor connected to the network interface circuit; and
a memory connected to the processor, the memory storing instructions executed by the processor to:
receive a registration request from the identification issuer machine,
assign a distributed identification (DID) to the identification issuer machine,
register the DID at the identification registry machine,
receive an identification request from the identification holder machine,
collect verified identification evidence from the identification validation machines, and
issue a verified identification credential with an associated Digital Identity Attribute Level (DIAL) to a holder wallet associated with a user of the identification holder machine, where the verified identification credential and DIAL in the holder wallet is accessible only with permission from the user of the identification holder machine, which is selectively granted to different machines over time to establish a reusable digital identity.

2. The apparatus of claim 1 further comprising instructions executed by the processor to:
receive an identification verification request,
retrieve the verified identification credential and DIAL from the holder wallet,
supply the verified identification credential to the identification verifier machine,
resolve the DID at the identification registry machine to establish a decentralized verification process, and
verify the verified identification credential and DIAL.

3. The apparatus of claim 1 wherein the DIAL is based upon self-attested data.

4. The apparatus of claim 1 wherein the DIAL is based upon third-party data.

5. The apparatus of claim 1 wherein the DIAL is based upon physical ID documents.

6. The apparatus of claim 1 wherein the DIAL is based upon biometric data.

7. The apparatus of claim 1 wherein the DIAL is based upon proof of liveness data.

8. The apparatus of claim 1 wherein the DIAL is based upon device data.

9. The apparatus of claim 1 wherein the DIAL is based upon network data.

10. The apparatus of claim 1 wherein the DIAL is based upon authoritative source data.

11. The apparatus of claim 1 wherein the DIAL is based upon knowledge-based authentication.

12. The apparatus of claim 1 wherein the DIAL is based upon two-factor authentication.

13. The apparatus of claim 1 wherein the verified identification credential is issued in accordance with an open standard created by the World Wide Web Consortium.

14. The apparatus of claim 1 wherein the DID is governed in a decentralized network.

15. The apparatus of claim 1 wherein the holder wallet is interoperable with proprietary digital wallets.
